(19) United States
(12) Patent Application Publication
(10) Pub. No.: US 2010/0091026 A1
(43) Pub. Date: Apr. 15, 2010

(54) DETECTING METHOD FOR DISPLAY DEVICE USING DRIVING CIRCUIT

(76) Inventors: Yang-Kai LIN, Taipei County (TW); Tsung-Hsiang Huang, Changhua County (TW)

Correspondence Address: Muncy, Geissler, Olds & Lowe, PLLC, P.O. BOX 1364, FAIRFAX, VA, 22038-1364, US

(21) Appl. No.: 12/565,469

(22) Filed: Sep. 23, 2009

(30) Foreign Application Priority Data
Oct. 15, 2008 (TW) 097139492

(51) Int. Cl. G09G 5/00

(52) U.S. Cl. 345/581

(57) ABSTRACT

A detecting method for a display device using a driving circuit is disclosed. The detecting method is used for controlling a field emission display (FED) and monitoring the operation of a driving circuit for the field emission display. The driving circuit can simulate an image by controlling a field programmable logic gate array (FPGA) and displaying the image through a computer simulating terminal according to image information and outputting the result of the simulation to a micro controlling unit (MCU) to complete feedback controlling.

### CROSS REFERENCE TO RELATED APPLICATIONS

This application claims priority of Taiwan Patent Application No. 097139492, filed on Oct. 15, 2008, the entirety of which is incorporated by reference herein.

### BACKGROUND OF THE INVENTION

1. Field of the Invention

The invention relates to detecting method for a display device, and more particularly to a detecting method for adjusting a field emission display using the feedback of the driving circuit of the field emission display.

2. Description of the Related Art

In general, when a driving circuit is used to drive a conventional field emission display (FED), image signals are generated from a television generator and subsequently outputted to an FED panel through a controller. More specifically, the FED panel is provided for displaying images according to the image signals.

Referring to FIG. 1, which is a block diagram illustrating a driving circuit for a field emission display (FED) according to the prior art. The field emission display driving circuit 1 comprises a television generator 11, a controller 12 and an FED panel 13. The television generator 11 generates an image signal for transmission to the controller 12. The controller 12 controls the image signal for output. With the control of the image signal from the controller 12, an expected image for designers is displayed on the FED panel 13 according to the image signal.

However, such a method may result in unexpected images being displayed on the FED panel due to control chip defects of the controller 12. Further, it is difficult to ascertain whether the unexpected images being displayed on the FED panel are induced by the panel or the controller. Therefore, a need exists in the art to overcome the aforementioned problem.

### BRIEF SUMMARY OF THE INVENTION

One objective of the invention provides a detecting method for adjusting a field emission display, comprising: providing an image signal for the field emission display; processing the image signal for outputting first image information and second image information according to the image signal; comparing the first image information and the second information to obtain an image information display result; adjusting the image signal according to the image information display result for outputting an adjusted image signal and displaying the adjusted image signal.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram illustrating a driving circuit for a field emission display according to the prior art;

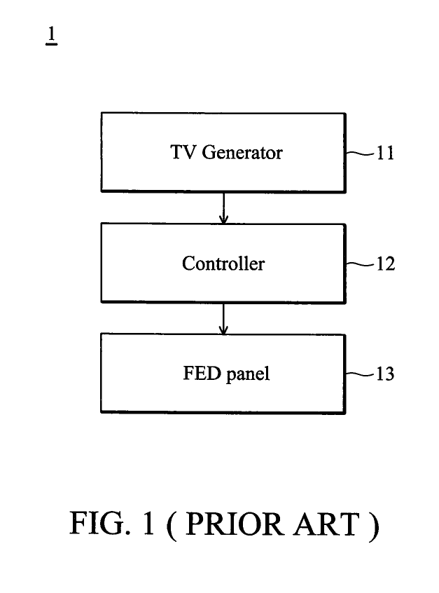

FIG. 2 is a block diagram illustrating a driving circuit for a field emission display according to an embodiment of the invention; and

FIG. 3 is a flowchart illustrating a detecting method using the driving circuit according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

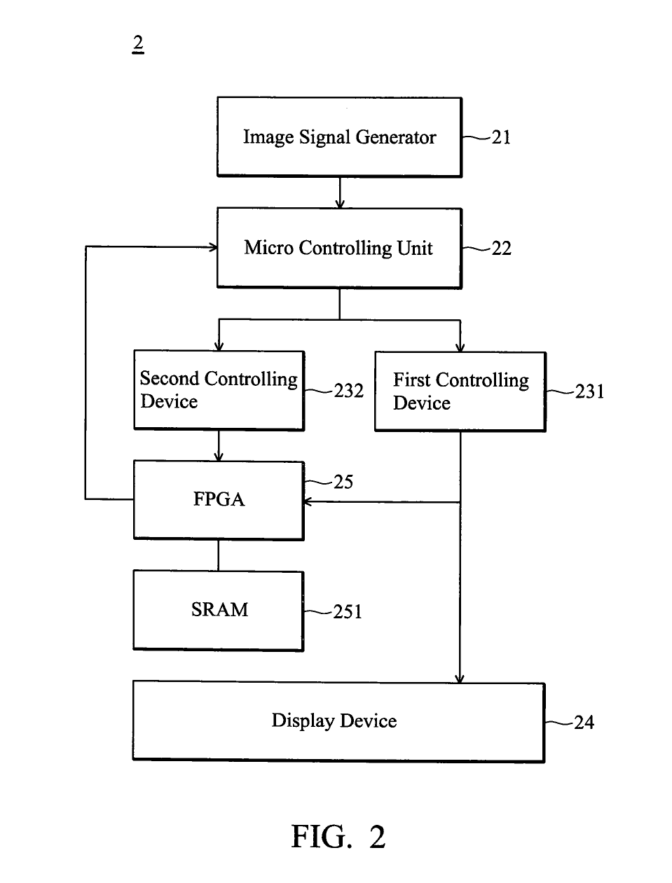

Referring to FIG. 2, which is a block diagram illustrating a driving circuit 2 for a field emission display according to an embodiment of the invention. As shown in FIG. 2, the driving circuit 2 for the field emission display comprises an image signal generator 21, a micro controlling unit 22, a first controlling device 231, a second controlling device 232, a display device 24 and a field programmable logic gate array (FPGA) 25.

The image signal generator 21 generates an image signal having image data for display. Thus, the display device 24 displays an image according to the image signal. The micro controlling unit 22 coupled to the image signal generator 21 is provided for receiving the image signal from the image signal generator 21 and outputting the image signal according to an externally inputted control signal.

According to one embodiment, the image signal may comprise multiple display signals, such as image signals for displaying time and channels. In this embodiment, the micro controlling unit 22 may output different image signals according to the control signal.

The first controlling device 231 and the second controlling device 232 are coupled to the micro controlling unit 22 for receiving the image signal outputted from the micro controlling unit 22 and generating first image information and second image information. The display device 24 is coupled to the first controlling device 231 for receiving the first image information outputted from the first controlling device 231 and displaying the image according the first image information from the first controlling device 231.

Further, the FPGA 25 is coupled to the first controlling device 231 and the second controlling device 232 for receiving the first image information from the first controlling device 231 and the second image information from the second controlling device 232. The FPGA 25 comprises an operational logic circuit for receiving the first and the second image information respectively from the first controlling device 231 and the second controlling device 232. The FPGA 25 stores the first and the second image information for comparing whether or not the first image information and the second image information are identical.

When the driving circuit 2 for the field emission display detects the normal condition, the first image information and the second image information are identical due to the image signal processed by the first controlling device 231 and the second controlling device 232 in same operation. Additionally, when the driving circuit 2 for the field emission display detects irregular condition, some error may be induced from the first controlling device 231 or the second controlling device 232 during processing of the image signal. In the irregular condition, the FPGA 25 compares the first image information and the second image information, generates a comparing signal according to the compared result and outputs the comparing signal to the micro controlling unit 22 for feedback controlling. Moreover, the micro controlling unit 22 adjusts the image signal according to the comparing signal generated by the FPGA 25.

In addition, the driving circuit 2 includes a scratch pad memory, such as a SRAM 251, coupled to the FPGA 25 as a buffer memory for the operation of the FPGA 25. Because the image information simultaneously outputted from the first controlling device 231 and the second controlling device 232 is significantly large, the FPGA 25 is unable to process and compare the image information immediately. Therefore, unprocessed signals may be temporarily stored into the SRAM 251. Consequently, a process for buffering the image information into the SRAM 251 is performed before it is actually read from the SRAM 251 for processing.

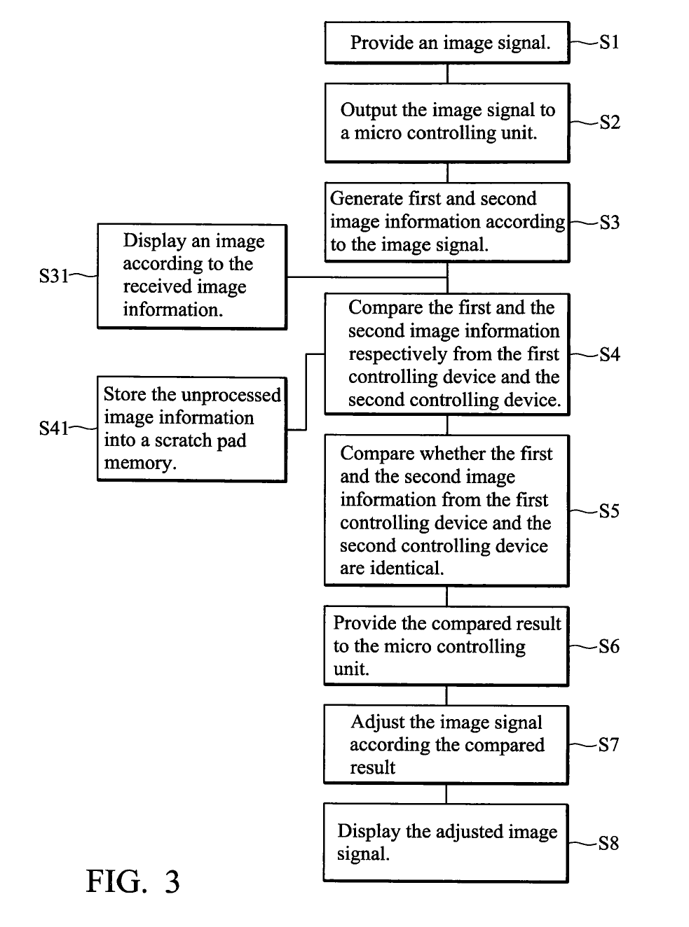

Referring to FIG. 3, which is a flowchart illustrating a detecting method using the driving circuit. As shown in FIGS. 2 and 3, an image signal is generated by an image signal generator 21 (step S1), outputted to a micro controlling unit 22, further controlled by the micro controlling unit 22 (step S2). The image signal is outputted to a first controlling unit 231 and a second controlling unit 232. The first controlling unit 231 and the second controlling unit 232 respectively output first image information and second image information according to the image signal (step S3). The first image information outputted from the first controlling device 231 is transmitted to a field programmable logic gate array (FPGA) 25 and a display device 24. Also, the second image information outputted from the second controlling device 232 is transmitted to the FPGA 25. The display 24 displays an image according to the received image information (step S31). The FPGA 25 compares the first and the second image information respectively from the first controlling device 231 and the second controlling device 232 (step S4), where the unprocessed image information is temporarily stored into a scratch pad memory, such as an SRAM 251 (step S41). The FPGA 25 may be provided with different logic circuits according to design requirements. According to this embodiment, the FPGA 25 compares the first image information and the second image information respectively outputted from the first controlling device 231 and the second controlling device 232 to determine whether or not the first image information and the second image information are identical (step S5). Following comparison, the FPGA 25 then determines whether the compared result is identical and outputs the compared result to the micro controlling unit 22 (step S6). Whether the compared result is identical or not, the micro controlling unit 22 then adjusts the image signal according to the compared result outputted from the FPGA 25 (step S7). Finally, the first controlling device 231 outputs the image information according to the adjusted image signal by the micro controlling unit 22. As a result, the adjusted image signal is displayed on the display device 24 (step S8).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A detecting method for adjusting a field emission display, comprising:
providing an image signal for the field emission display;
processing the image signal for outputting first image information and second image information according to the image signal;
comparing the first image information and the second information to obtain an image information display result;
adjusting the image signal according to the image information display result for outputting an adjusted image signal; and
displaying the adjusted image signal.

2. The detecting method as claimed in claim 1, wherein a field programmable logic gate array is provided for comparing the first image information and the second image information.

3. The detecting method as claimed in claim 1, wherein the image signal is generated from an image signal generator.
